(19) United States
(12) Patent Application Publication
(10) Pub. No.: US 2008/0083751 A1
(43) Pub. Date: Apr. 10, 2008

(54) Insulated microwave tray holder

(76) Inventors: Danny Berryhill, (US); Larry McHaney, (US)

Correspondence Address: LARRY McHANEY, 26 SOUTH MAGNOLIA POND PL., THE WOODLANDS, TX, 77381, US

(21) Appl. No.: 11/529,717

(22) Filed: Sep. 19, 2006

(51) Int. Cl. H05B 6/80

(52) U.S. Cl. 219/730

(57) ABSTRACT

A perforation in the top or bottom of the outer food packaging that matches the bottom outline of the inner microwave cooking tray, that when the perforated area is punched in, enables the cooking tray with the pre-prepared food to be placed directly in the opening. This allows the inner food tray to be heated, and the entire unit handled and placed on surfaces without the use of hot pads or other protective gear.

### CROSS-REFERENCE TO RELATED APPLICATIONS

As of this date the applicant is not aware of any prior art that is obvious or relevant to the present invention. U.S. Pat. No. 4,305,543 describes a way to fabricate a cardboard tray, and U.S. Pat. No. 6,559,431 describes a microwave cooking tray with a sleeve assembly, but neither describe the invention herein.

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISC APPENDIX

Not Applicable

### BACKGROUND OF THE INVENTION

The present invention relates to the field of prepackaged microwave food containers and cooking devices. More particularly, the present invention relates to a method to utilize a prepackaged food container as an insulator and serving tray.

Consumers often prefer to cook food in a microwave oven rather than conventional ovens because of the reduced cooking time required to heat foods in a microwave oven. Unfortunately, cooking food in a microwave oven can be a troublesome task due to the intense heat generated in the food itself, which is transferred to the tray or container the food is packaged in. In addition, microwave ovens do not evenly distribute heat to the product being cooked. This results in a cooked food product that may be very hot in one area, but cold in another area. When turning the container, oftentimes an oven mitt or other insulator has to be used to prevent burns to human hands. Due to the intense heat of the cooked food, and thereby food tray, insulated pads have to be used to prevent damage to the surface the tray is set upon, or a plate has to be used to transfer the food product to.

Consumers want to be provided the opportunity to cook pre-packaged food products in the package they were purchased in, without the trouble of transferring the food from one container to the next or creating additional mess by transferring the food to a plate or microwave cookware.

Consumers also want to be able to conveniently eat the heated food with or without the use of TV dinner trays, other folding or non-folding tray devices, or even a table surface.

### BRIEF SUMMARY OF THE INVENTION

A perforation in the top or bottom of the outer package that matches the outline of the cooking tray, that when the perforated area is punched in, enables the cooking tray with the pre-prepared food to be placed directly in.

### BRIEF DESCRIPTION OF THE SEVERAL VIEWS OF THE DRAWING

FIG. 1 shows a perspective view of a microwave cooking tray with the tray removed from the package; ready to be inserted into the outer package container after the perforated center material is punched down.

FIG. 2 shows another embodiment with a different shaped food tray removed from the package; ready to be inserted into the outer package container after the perforated center material is punched down.

FIG. 3 shows a side view of the outer package container with the food tray inserted after punching of the center material, thereby being ready to microwave.

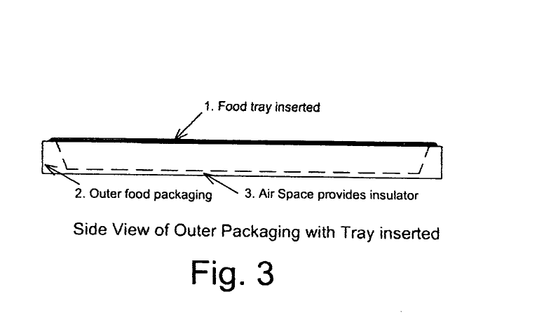

FIG. 4. shows a cardboard blank with the perforation for the food tray, prior to folding and securing by the manufacturing process.

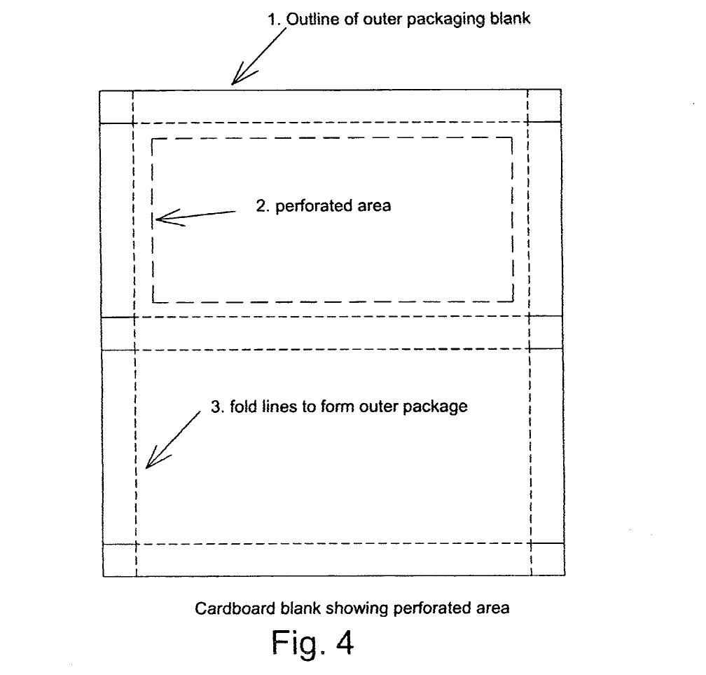

### DETAILED DESCRIPTION OF THE INVENTION

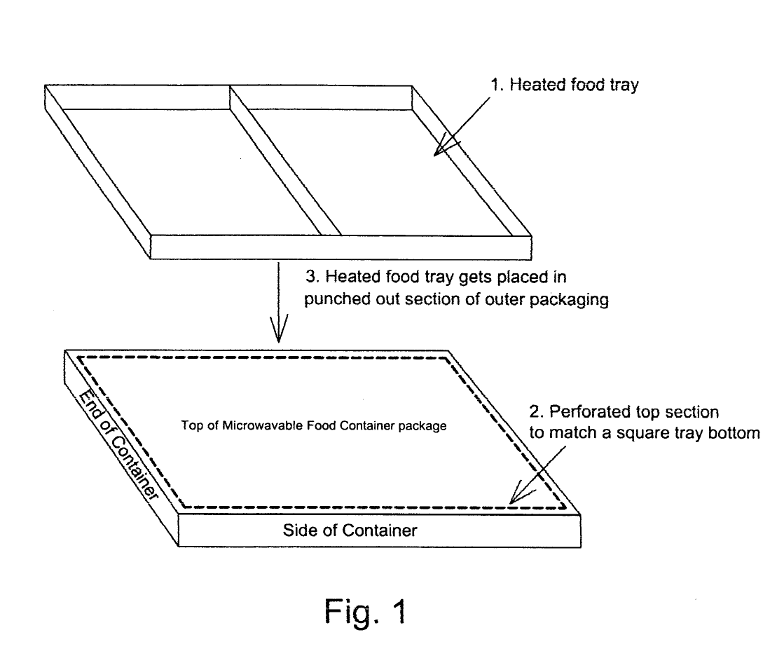

With reference to FIG. 1, the outer food package blank will be perforated in the manufacturing process to provide an easy to punch out area that matches the bottom of the cooking tray unit holding the food. The perforations are such that the outer packing is still strong enough for shipping and handling, yet easy for the consumer to punch out with their finger or other object.

The perforated top section 2. is punched out by the consumer with either their finger or utensil, and heated food tray 3. is placed into the hole created in the box. The entire unit is then placed in the microwave to be heated and turned and manipulated as the cooking directions may state. Due to height and width differences in the food tray and the outer food package, an air space is created whereby the outer food package does not absorb heat energy from the food as does the food tray. The amount of air space is variable, depending upon the design size of the food tray and the outer food package.

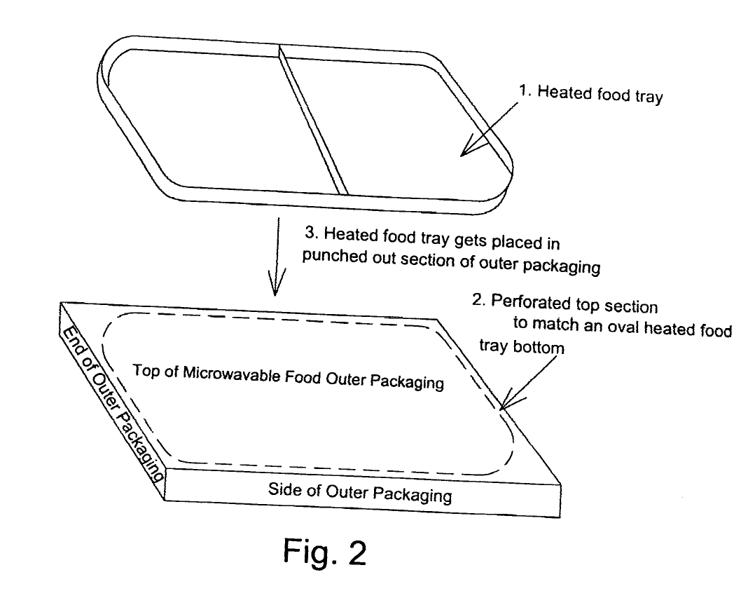

FIG. 2 shows another embodiment of the system showing an oval shaped bottom of the food tray for clarification purposes. Any shape food tray may be matched with the appropriate shaped perforations in the outer food packaging so that it may be used in the manner described herein.

These are but a few of the variations of the improvement described herein, and other variations are possible. Therefore, the spirit and scope of the claimed invention should not be limited to the description of the preferred versions contained herein. The perforated area would be sized and shaped to fit the inner food tray, regardless of shape thereby creating an insulated system that is easy to handle and serve, providing a convenient lap tray or holder, and thereby reducing the use of plates or other serving items, and as a result, conserving the water and energy that would be used to clean the plate.

Existing systems of production of packaging can be utilized with minor changes to the tooling to provide the correct perforated size and shape thereby saving investment on new production line equipment. The addition of a set of cutting edges in the stamp out die that produces the blank for the outer packaging will provide the perforations necessary for the invention.

What is claimed is:

1. An improvement on the conventional prepackaged container and microwave cooking process by creating a perforated outline on the outer packaging that matches the inner packaging food tray bottom, that can be easily punched out, enabling the food tray to be inserted therein, thereby creating a method of heating the food and carrying the container without having to use gloves, hot pads, or other methods of protection against heat for hands or surfaces the container may be placed upon as well as reducing the cleanup necessary after serving and eating the food.
